(19) United States
(12) Patent Application Publication
(10) Pub. No.: US 2026/0131839 A1
(43) Pub. Date: May 14, 2026

(54) FOLDING CART WITH SEAT

(71) Applicant: Zhejiang Pride Leisure Products Co,. Ltd., Jinhua (CN)

(72) Inventor: Benlong SUN, Jinhua (CN)

(21) Appl. No.: 19/385,049

(22) Filed: Nov. 10, 2025

(30) Foreign Application Priority Data
Nov. 8, 2024 (CN) 202422724708.3

(51) Int. Cl. B62B 3/02; B62B 3/00; B62B 5/00; B62B 5/06; B62B 5/08

(52) U.S. Cl. CPC B62B 3/02; B62B 3/002; B62B 5/0013; B62B 5/061; B62B 5/082; B62B 2205/06; B62B 2205/30

(57) ABSTRACT

A folding cart with a seat having a cart frame. The cart frame having frames located at front and rear ends, a bottom folding frame rotatably connected between the two frames, and side folding frames located on two sides, wherein two ends of each side folding frame are rotatably connected to the frames at the front and rear ends respectively, and two ends of the bottom folding frame are rotatably connected to the frames at the front and rear ends respectively. A detachable seat is arranged on the cart frame. When users participate in an outdoor activity with a child, the child can sit on the seat, such that the folding cart can carry both goods and the child, and the users do not need to pay more attention to the child and can better enjoy the outdoor activity.

### BACKGROUND OF THE INVENTION

### 1. Technical Field

The disclosure relates to the technical field of folding carts, in particular to a folding cart with a seat.

### 2. Description of Related Art

In outdoor activities, such as camping, fishing and photographing, which are becoming increasingly popular, many articles are often carried and manually transferred to the destination, which is not only time-consuming but also labor-consuming. In view of this, carts are purchased to push or pull a great many articles to the destination in outdoor activities. For the sake of convenience, folding carts that can be easily carried outdoors by users appear in the market, the folding carts, when not used, can be folded to occupy a small space.

Existing folding carts can only function for transferring goods. In a case where users participate in an outdoor activity with a child, the users cannot pay full attention to the child when pushing or pulling the folding cart, thus failing to take good care of the child.

### BRIEF SUMMARY OF THE INVENTION

To overcome the defects in the prior art, the disclosure provides a folding cart with a seat. To solve the abovementioned technical problems, the disclosure provides the following technical solution.

A folding cart with a seat comprises a cart frame and casters mounted at a bottom of the cart frame, wherein the cart frame comprises frames located at front and rear ends of the cart frame, a bottom folding frame rotatably connected between the two frames, and side folding frames located on two sides of the cart frame, two ends of each side folding frame are rotatably connected to the frames at the front and rear ends respectively, two ends of the bottom folding frame are rotatably connected to the frames at the front and rear ends respectively, and a detachable seat is arranged on the cart frame.

Further, connecting buckles are arranged on two sides and a back of the seat, the connecting buckles on the two sides are mounted on the side folding frames, and the connecting buckle on the back is mounted on the corresponding frame.

Further, mounting blocks are arranged on two sides of a top of each frame, movable rods are rotatably connected to inner sides of the mounting blocks, upper ends of the side folding frames are rotatably connected to the movable rods, and lower ends of the side folding frames are rotatably connected to lower ends of the frames.

Further, each side folding frame comprises two X-frames that are hinged together, each X-frame comprises a first side rod and a second side rod, a center of the first side rod and a center of the second side rod are movably riveted, an outer end of the first side rod is hinged to the corresponding movable rod, an outer end of the second side rod is hinged to the lower end of the corresponding frame, and the side folding frames are folded by rotation of the movable rods.

Further, each side frame comprises two X-frames that are hinged together, each X-frame comprises a first side rod and a second side rod, a center of the first side rod and a center of the second side rod are movably riveted, connecting rods parallel to a horizontal plane are arranged at an inner end of the first side rod and an inner end of the second side rod, inner ends of the two X-frames are connected by hinging together the connecting rods, outer ends of the two X-frames are respectively hinged to the corresponding movable rods and the lower end of the corresponding frame by means of the first side rods and the second side rods, and the side folding frames are folded by rotation of the movable rods.

Further, a detachable storage box is mounted on the connecting rods, connecting buckles are arranged at two ends of the storage box, and the storage box is detachably mounted on the connecting rods by means of the connecting buckles.

Further, the bottom folding frame comprises two bottom frames located at the front and back ends and rotating members used for connecting the two bottom frames, and each bottom frame has an end hinged into the rotary members as well as an end hinged to a lower end of the corresponding frame.

Further, a canopy is arranged on the cart frame and comprises a canopy frame and a curtain, the canopy frame is inserted into upper ends of the frames, and the curtain is disposed around the canopy frame; and the canopy frame comprises a plurality of vertical rods, connecting pieces mounted at tops of the vertical rods, a plurality of horizontal rods rotatably mounted on the connecting pieces, and a connecting base located at a center and used for connecting the plurality of horizontal rods, and the horizontal rods are rotatably connected to the connecting base.

Further, a handle is arranged at the rear end of the cart frame and rotatably connected to an upper end of the frame at the rear end.

Further, a telescopic pull rod is arranged at the front end of the cart frame and hinged to the frame at the front end, and a grip ring is arranged at a top of the pull rod.

Compared with the prior art, the disclosure fulfils the following beneficial effects:

The cart frame comprises the frames located at the front and rear ends, the bottom folding frame rotatably connected between the two frames, and the side folding frames located on the two sides, the two ends of each side folding frame are rotatably connected to the frames at the front and rear ends respectively, the two ends of the bottom folding frame are rotatably connected to the frames at the front and rear ends respectively, and when the side folding frames and the bottom folding frame are folded, the two frames are driven to draw close to each other to fold the cart frame, and after being folded, the folding cart occupies a small space, is easy to store, can be easily carried outdoors by users, and can be easily packaged and delivered by manufactures.

The detachable seat is arranged on the cart frame; when users participate in an outdoor activity with a child, the seat can be installed on the cart frame to allow the child to sit thereon, such that the folding cart can carry both goods and the child and has more functions, and the users do not need to pay more attention to the child and can better enjoy the outdoor activity.

### BRIEF DESCRIPTION OF THE SEVERAL VIEWS OF THE DRAWINGS

FIG. 1 is a first perspective view according to the disclosure.

FIG. 2 is a first side view according to the disclosure.

FIG. 3 is a second perspective view according to the disclosure.

FIG. 4 is a second side view according to the disclosure.

FIG. 5 is a perspective view of a canopy frame according to the disclosure.

Reference signs: 1, cart frame; 2, caster; 3, frame; 4, bottom folding frame; 5, side folding frame; 6, seat; 7, connecting buckle; 8, safety belt; 9, mounting block; 10, movable rod; 11, X-frame; 12, first side rod; 13, second side rod; 14, connecting rod; 15, bottom frame; 16, rotating member; 17, storage box; 18, canopy; 19, canopy frame; 20, curtain; 21, vertical rod; 22, connecting piece; 23, horizontal rod; 24, connecting base; 25, handle; 26, pull rod; 27, grip ring.

### DETAILED DESCRIPTION OF THE INVENTION

The technical solutions in the embodiments of the disclosure are clearly and completely described below in conjunction with accompanying drawings of these embodiment. Obviously, the embodiments in the following description are merely illustrative ones and are not all possible ones of the disclosure. All other embodiments obtained by those skilled in the art based on the following ones without creative labor should also fall within the protection scope of the disclosure.

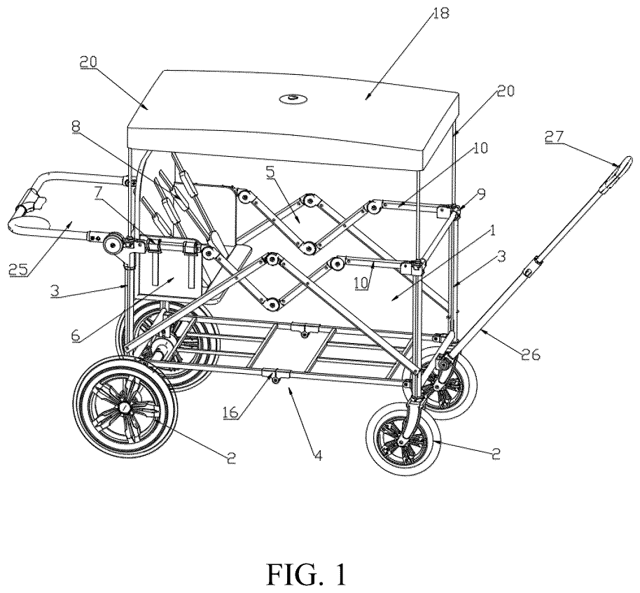

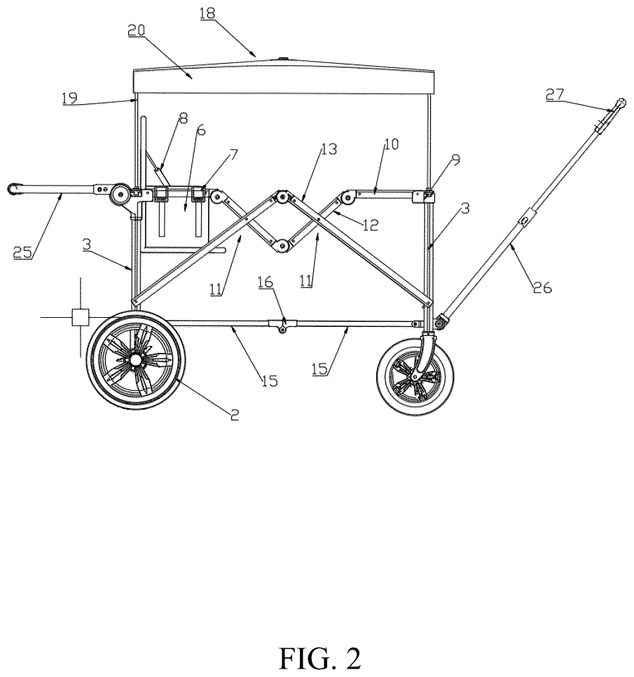

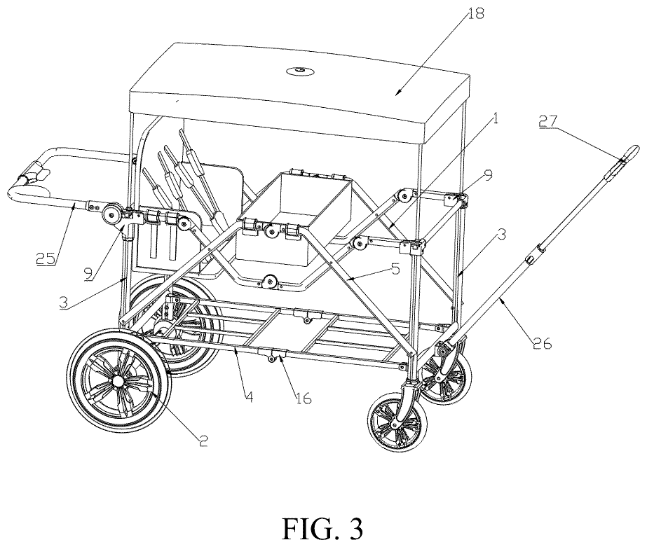

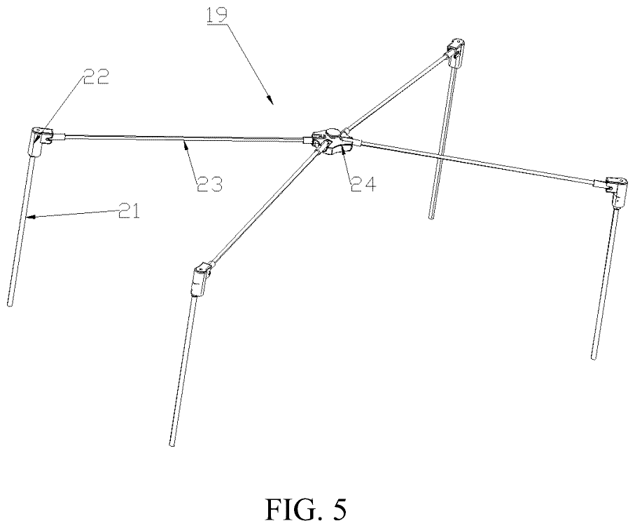

As shown in FIGS. 1-5, a folding cart with a seat comprises a cart frame 1 and casters 2 mounted at the bottom of the cart frame 1, wherein the cart frame 1 comprises frames 3 located at front and rear ends of the cart frame, a bottom folding frame 4 rotatably connected between the two frames 3, and side folding frames 5 located on two sides of the cart frame, two ends of each side folding frame 4 are rotatably connected to the frames 3 at the front and rear ends respectively, two ends of the bottom folding frame 5 are rotatably connected to the frames 3 at the front and rear ends respectively, and when the side folding frames 4 and the bottom folding frame 5 are folded, the two frames 3 are driven to draw close to each other to fold the cart frame 1, and after being folded, the folding cart occupies a small space, is easy to store and can be easily carried outdoors by users. A detachable seat 6 is arranged on the cart frame 1. When users participate in an outdoor activity with a child, the seat 6 can be installed on the cart frame 1 to allow the child to sit thereon, such that the folding cart has more functions and can carry both goods and the child, and the users do not need to pay more attention to the child and can better enjoy the outdoor activity.

Connecting buckles 7 are arranged on two sides and a back of the seat 6, the seat is assembled from top to bottom and fixed by means of the connecting buckles 7, the connecting buckles 7 on the two sides are mounted on the side folding frames 5, the connecting buckle 7 on the back is mounted on the frame 3 at the rear end of the cart frame 1, the connecting buckles 7 are arranged on rods of the cart frame body 1 a U shape, and users can assemble or disassemble the seat 6 according to personal requirements. The seat can be pulled upwards to be taken out and is easy to assemble or disassemble, thus satisfying the requirement for convenience of users. A safety belt 8 is arranged on the seat 6, and a child sitting on the seat 6 is fastened by means of the safety belt to be prevented from falling off from the seat 6 in the moving process of the folding cart.

Mounting blocks 9 are arranged on two sides of the top of each frame 3, movable rods 10, four in total, are rotatably connected to inner sides of the mounting blocks 9, upper ends of the side folding frames 5 are rotatably connected to the movable rods 10, and lower ends of the side folding frames 6 are rotatably connected to lower ends of the frames 3. When the side folding frames 5 are folded, the frames 3 can be folded without being elevated by means of rotation of the movable rods 10, such that the folding cart can be easily packaged and delivered by manufactures. The movable rods 10 are hinged into the mounting blocks 9 which are open upwards, and cannot rotate downwards, and when the cart frame 1 is in an unfolded state, the movable rods 10 are parallel to the horizontal plane, and the connecting buckles 7 on the two sides of the seat 6 are mounted on the corresponding movable rods 10.

Embodiment 1: As shown in FIG. 1, each side folding frame 5 comprises two X-frames 11 that are hinged together, each X-frame 11 comprises a first side rod 12 and a second side rod 13, the first side rod 12 is not as long as the second side rod 12, and the center of the first side rod 12 and the center of the second side rod 13 are movably riveted, such that the first side rod 12 and the second side rod 13 can rotate around a rivet joint; and an outer end of the first side rod 12 is hinged to the corresponding movable rod 10, and an outer end of the second side rod 13 is hinged to the lower end of the corresponding frame 3. When the side folding frames 10 are folded, the movable rods 10 rotate upwards to drive the X-frames 11 to rotate to fold the side folding frames 5.

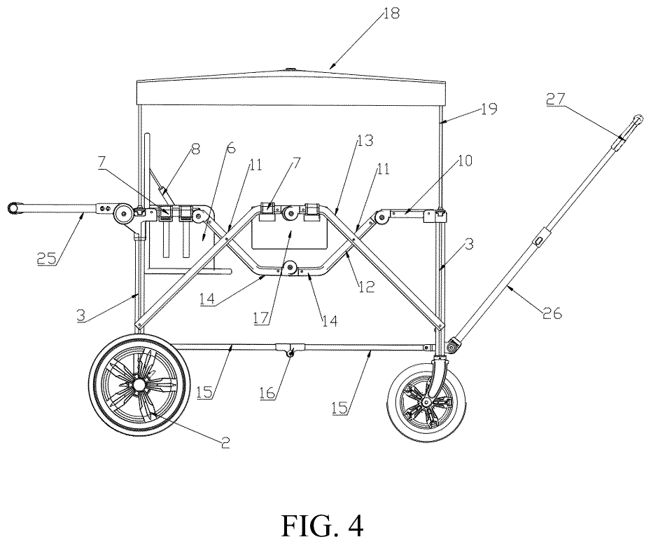

Embodiment 2: As shown in FIG. 4, each side folding frame 5 comprises two X-frames 11 that are hinged together, each X-frame 11 comprises a first side rod 12 and a second side rod 13, the first side rod 12 is not as long as the second side rod 12, and the center of the first side rod 12 and the center of the second side rod 13 are movably riveted, such that the first side rod 12 and the second side rod 13 can rotate around a rivet point; connecting rods 14 parallel to the horizontal plane are arranged at an inner end of the first side rod 12 and an inner end of the second side rod 13, inner ends of the two X-frames 11 are connected by hinging together the connecting rods 14, and outer ends of the two X-frames 11 are respectively hinged to the corresponding movable rods 10 and the lower end of the corresponding frame 3 by means of the first side rods 12 and the second side rods 13. When the side folding frames 5 are folded, the movable rods 10 rotate upwards to drive the X-frames 11 to rotate to fold the side folding frames 5. A detachable storage box 17 is mounted on the connecting rods 14 and located in front of the seat 6. The storage box 7 is mounted in the same way as the seat 6, that is, connecting buckles 7 are arranged at two ends of the storage box 17, and the storage box 17 is detachably mounted on the connecting rods 14 by means of the connecting buckles 7. When a child sits on the seat 6, articles can be placed in the storage box 17 to be stored. When not used, the storage box 17 can be pulled upwards to be taken out, and the storage box 17 is easy to assemble and disassemble.

The bottom folding frame 4 comprises two bottom frames 15 located at the front and back ends and rotating members 16 used for connecting the two bottom frames 15, one end of each bottom frame 15 is hinged into the rotary members 16, the other end of each bottom frame 15 is hinged to the lower end of the corresponding frame 3. When the bottom folding frame 4 is folded, the rotating members 16 move upwards to drive the two bottom frames 15 to rotate and draw close to each other, and the bottom frames 15 drive the two frames 3 to draw close to each other. Each rotating member 16 is formed by two hinges that are hinged together, and the rotating members 16 are connected to the bottom frames 15 and used for driving the bottom frames 15 to rotate to be folded.

A canopy 18 is arranged on the cart frame 1 and comprises a canopy frame 19 and a curtain 20, the canopy frame 19 is inserted into upper ends of the frames 3 and is detachable, and the curtain 20 is disposed around the canopy frame 19 and used for shading sun and rain. Users can assemble and disassemble the canopy 18 according to personal use requirements.

The canopy frame 19 comprises four vertical rods 21, connecting pieces 22 mounted at tops of the vertical rods 21, horizontal rods 23 rotatably mounted on the connecting pieces 22, and a connecting base 24 located at the center and used for connecting the four horizontal rods 23, wherein one end of each horizontal rod 23 is rotatably connected to the corresponding connecting piece 22, and the other end of each horizontal rod 23 is rotatably connected to the connecting base 24. The canopy frame 19 can be folded to be easily carried outdoors.

A handle 25 is arranged at a rear end of the cart frame 1 and rotatably connected to the upper end of the frame 1 at the rear end. Users can push the folding cart behind the cart frame 1 by means of the handle 25, and when not used, the handle 25 can be rotated to be stored, such that the space occupied by the folding cart is reduced.

A telescopic pull rod 26 is arranged at a front end of the cart frame 1 and hinged to the frame 1 at the front end, and users can pull the folding cart to move by means of the pull rod 19. The pull rod 26 may be telescopic rod and can rotate, and users can adjust the pull rod 26 to a suitable height according to their height, such that the folding cart can be pulled by users with different heights. A grip ring 27 is arranged at the top of the pull rod 26, and users can grip the grip ring 27 when pulling the folding cart, such that the pull rod 26 is prevented from slipping out of user's hands.

It is obvious for those skilled in the art that the disclosure is not limited to the details of the illustrative embodiments described above and can be implemented in other specific forms without departing from the spirit or basic features of the disclosure. Therefore, from any perspective, the above embodiments should be construed as illustrative rather than restrictive. The scope of the disclosure should be defined by the appended claims rather than the above description. Therefore, all variations falling within the concept and scope of equivalents of the claims should be included in the disclosure. Any reference sign in the claims should not be construed as a limitation of the claims involved.

What is claimed is:

1. A folding cart with a seat, comprising:
a cart frame and casters mounted at a bottom of the cart frame;
wherein the cart frame comprises a front frame located at a front and a rear frame located at a rear ends of the cart frame, a bottom folding frame rotatably connected between the front and rear frames, and a plurality of side folding frames located on two sides of the cart frame;
wherein two ends of each said plurality of side folding frame are rotatably connected to the front and rear frames, respectively;
wherein two ends of the bottom folding frame are rotatably connected to the front and rear frames, respectively; and
wherein a detachable seat is arranged on the cart frame.

2. The folding cart with a seat according to claim 1, wherein connecting buckles are arranged on two sides and a back of the seat, the connecting buckles on the two sides are mounted on the plurality of side folding frames, and the connecting buckle on the back is mounted on the cart frame.

3. The folding cart with a seat according to claim 1, wherein mounting blocks are arranged on two sides of a top of each said frame, movable rods are rotatably connected to inner sides of the mounting blocks, upper ends of the plurality of side folding frames are rotatably connected to the movable rods, and lower ends of the plurality of side folding frames are rotatably connected to lower ends of the frames.

4. The folding cart with a seat according to claim 3, wherein each said plurality of side folding frames comprises two X-frames that are hinged together, each said X-frame comprises a first side rod and a second side rod, a center of the first side rod and a center of the second side rod are movably riveted, an outer end of the first side rod is hinged to the corresponding movable rod, an outer end of the second side rod is hinged to the lower end of the corresponding frame, and the side folding frames are folded by rotation of the movable rods.

5. The folding cart with a seat according to claim 3, wherein each said plurality of side frames comprises two X-frames that are hinged together, each said X-frame comprises a first side rod and a second side rod, a center of the first side rod and a center of the second side rod are movably riveted, connecting rods parallel to a horizontal plane are arranged at an inner end of the first side rod and an inner end of the second side rod, inner ends of the two X-frames are connected by hinging together the connecting rods, outer ends of the two X-frames are respectively hinged to the corresponding movable rods and the lower end of the corresponding frame by means of the first side rods and the second side rods, and the side folding frames are folded by rotation of the movable rods.

6. The folding cart with a seat according to claim 5, wherein a detachable storage box is mounted on the connecting rods, connecting buckles are arranged at two ends of the storage box, and the storage box is detachably mounted on the connecting rods by means of the connecting buckles.

7. The folding cart with a seat according to claim 1, wherein the bottom folding frame comprises two bottom frame portions located at the front and back ends and rotating members used for connecting the two bottom frame portions, and each said bottom frame portion has an end hinged into the rotary members as well as an end hinged to a lower end of the corresponding frame.

8. The folding cart with a seat according to claim 1, wherein a canopy is arranged on the cart frame and comprises a canopy frame and a curtain, the canopy frame is inserted into upper ends of the frames, and the curtain is disposed around the canopy frame; and the canopy frame comprises a plurality of vertical rods, connecting pieces mounted at tops of the vertical rods, a plurality of horizontal rods rotatably mounted on the connecting pieces, and a connecting base located at a center and used for connecting the plurality of horizontal rods, and the horizontal rods are rotatably connected to the connecting base.

9. The folding cart with a seat according to claim 1, wherein a handle is arranged at the rear end of the cart frame and rotatably connected to an upper end of the frame at the rear end.

10. The folding cart with a seat according to claim 1, wherein a telescopic pull rod is arranged at the front end of the cart frame and hinged to the frame at the front end, and a grip ring is arranged at a top of the pull rod.
